(19) United States
(12) Patent Application Publication
(10) Pub. No.: US 2018/0063637 A1
(43) Pub. Date: Mar. 1, 2018

(54) Side Diaphragm with a Waterproof Function and Microspeaker Having the Same

(71) Applicant: EM-TECH. Co., Ltd., Busan (KR)

(72) Inventors: Ji Hun Choi, Gyeongsangnam-do (KR); Kil Dong Park, Busan (KR); Sung Jun Lee, Gyeongsangnam-do (KR); Jung Heon Kim, Gyeongsangnam-do (KR)

(21) Appl. No.: 15/683,270

(22) Filed: Aug. 22, 2017

(30) Foreign Application Priority Data
Aug. 23, 2016 (KR) 1020160107133

(51) Int. Cl. H04R 1/44; H04R 9/02; H04R 9/06; H04R 7/18; H04R 7/04

(52) U.S. Cl. CPC H04R 1/44; H04R 9/025; H04R 2400/11; H04R 7/18; H04R 7/04; H04R 9/06

(57) ABSTRACT

The present invention discloses a side diaphragm with a waterproof function that can resist a water pressure over 1 atm. According to the present invention, there is provided a side diaphragm with a waterproof function that is provided in a microspeaker, the side diaphragm including a planar center portion, a planar outer peripheral portion, and a ring-shaped dome portion projecting upward between the center portion and the outer peripheral portion, wherein there is no perforated part and the dome portion does not have additional pleats.

### PRIORITY CLAIM

The present application claims priority to Korean Patent Application No. 10-2016-0107133 filed on 23 August 2016, the content of said application incorporated herein by reference in its entirety.

### TECHNICAL FIELD

The present invention relates to a side diaphragm with a waterproof function, and more particularly, to a side diaphragm with a waterproof function that can resist a water pressure over 1 atm and a microspeaker having the same.

### BACKGROUND

Recently, mobile devices equipped with microspeakers, in particular, mobile phones have been released with a waterproof function.

For the waterproof mobile phones, a connection hole through which a charger is connected to the inner part of the mobile phone can be removed using wireless charging, while a connection hole through which an earphone jack is connected to the inner part of the mobile phone can be removed using Bluetooth. However, a speaker essentially requires a sound-emitting hole, so its hole communicating with the inner part of the mobile phone cannot be removed. Therefore, there is the need for developing a microspeaker mounted in a mobile phone that performs a waterproof function and has a structure capable of preventing the inflow of water into the mobile phone.

The present applicant has already registered a patent application for a microspeaker with a waterproof structure capable of preventing the inflow of water. FIG. 1 shows a waterproof structure of a side diaphragm, as disclosed in Korea Patent No. 10-1559304 of the present applicant.

A suspension 40 includes a ring-shaped outer peripheral portion 43 with a perforated center that is seated on a frame (not shown), a center portion 41 located at the perforated center with a spacing from the outer peripheral portion 43, and a connection portion 42 connecting the center portion 41 and the outer peripheral portion 43 and elastically supporting the center portion 41.

In addition, a diaphragm 50 includes a planar center portion 51, a planar outer peripheral portion 53, and a ring-shaped dome portion 52 projecting upward between the center portion 51 and the outer peripheral portion 53.

As the center portion 51 of the diaphragm 50 is attached to the center portion 41 of the suspension 40, the outer peripheral portion 53 of the diaphragm 50 is attached to the outer peripheral portion 43 of the suspension 40. The attachment of the suspension 40 and the diaphragm 50 is performed using a double-sided tape or thermal compression. The dome portion 52 of the diaphragm 50 serves as a side diaphragm, while the parts of the center portion 51 of the diaphragm 50 and the center portion 41 of the suspension 40 that are attached to each other serve as a center diaphragm. A diaphragm, in which a center diaphragm and a side diaphragm are simply integrally formed, is disadvantageous in reproducing a low-frequency sound due to the low rigidity of the center diaphragm. However, a vibration portion described in Korea Patent No. 10-1559304 has the advantage of enhancing low-frequency sound characteristics because the center portion 41 of the suspension 40 and the center portion 51 of the diaphragm 50 are attached to each other to perform low-frequency reproduction. In addition, as compared with a center diaphragm separately manufactured and then attached to the suspension 40 or the side diaphragm, there is no perforated part at the center of the side diaphragm, which leads to the improved waterproof airtightness.

However, due to the pleats of the comb pattern formed at the corners of the side diaphragm, a buckling phenomenon occurs over a predetermined pressure, which is not restored. Although the diaphragm should have a high elastic (or restoring) force to be able to resist a pressure over 1 atm, the comb pattern formed at the corners of the side diaphragm facilitates upward and downward amplitudes but reduces elasticity.

Therefore, there is the need for developing a side diaphragm with an improved waterproof function that can resist a pressure over 1 atm.

### SUMMARY

An object of the present invention is to provide a side diaphragm with a waterproof function that can resist a water pressure over 1 atm.

According to an aspect of the present invention, there is provided a side diaphragm with a waterproof function that is provided in a microspeaker, said side diaphragm comprising a planar center portion, a planar outer peripheral portion, and a ring-shaped dome portion projecting upward between the center portion and the outer peripheral portion, wherein there is no perforated part and the dome portion does not have additional pleats.

In some embodiments, the side diaphragm is generally formed in a rectangular shape, and the dome portion has four corner parts and four straight parts, the highest point of the dome portion at the straight part being located further outward than the center of the width of the dome portion.

In some embodiments, the side diaphragm is generally formed in a rectangular shape, and the dome portion has four corner parts and four straight parts, the highest point of the dome portion at the corner part being located further inward than the center of the width of the dome portion.

In some embodiments, the height of the center portion is equal to or lower than the height of the outer peripheral portion.

In some embodiments, the ratio of the height of the dome portion to the width of the dome portion is equal to or greater than 0.35.

In some embodiments, the diaphragm has a thickness of at least 30 μm.

According to another aspect of the present invention, there is provided a microspeaker, comprising a frame, a magnetic circuit disposed in the frame, a side diaphragm as described above, a voice coil attached to the side diaphragm, and a protector coupled to the upper portion of the frame and closely attached to the outer periphery of the side diaphragm, wherein the protector wholly is made of an SUS material.

In some embodiments, the protector and the side diaphragm are attached using a silicon bond.

The side diaphragm with the waterproof function according to the present invention can maintain the performance at a water pressure over 1 atm, with the improved elasticity, by removing the pleats (comb pattern) formed at the corners of the dome portion.

Those skilled in the art will recognize additional features and advantages upon reading the following detailed description, and upon viewing the accompanying drawings.

### BRIEF DESCRIPTION OF THE DRAWINGS

FIG. 1 shows a waterproof structure of a conventional side diaphragm.

FIG. 2 shows a side diaphragm with a waterproof function according to an exemplary embodiment of the present invention.

FIG. 3 is a detailed view showing a dome portion of the side diaphragm with the waterproof function according to the exemplary embodiment of the present invention.

FIG. 4 is a sectional view showing part of the side diaphragm with the waterproof function according to the exemplary embodiment of the present invention.

FIG. 5 shows an example of a microspeaker having a side diaphragm with a waterproof function according to the present invention.

FIG. 6 is a photographic image of a comparative side diaphragm with a waterproof function, after applying a water pressure of 1 atm thereto.

FIG. 7 is a photographic image of the side diaphragm with the waterproof function according to the exemplary embodiment of the present invention, after applying a water pressure of 1 atm thereto.

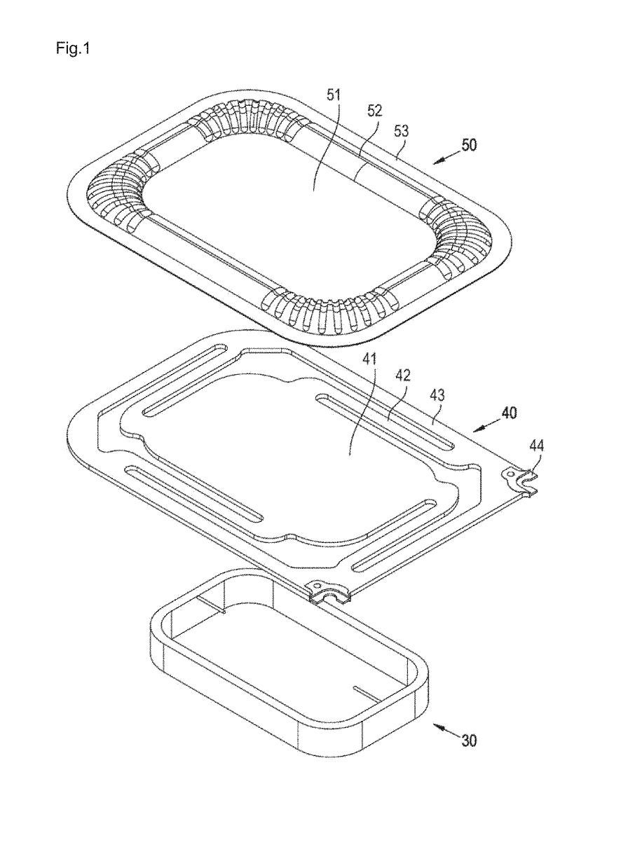

### DETAILED DESCRIPTION

Hereinafter, a preferred embodiment of a side diaphragm with a waterproof function according to the present invention will be described in detail with reference to the accompanying drawings.

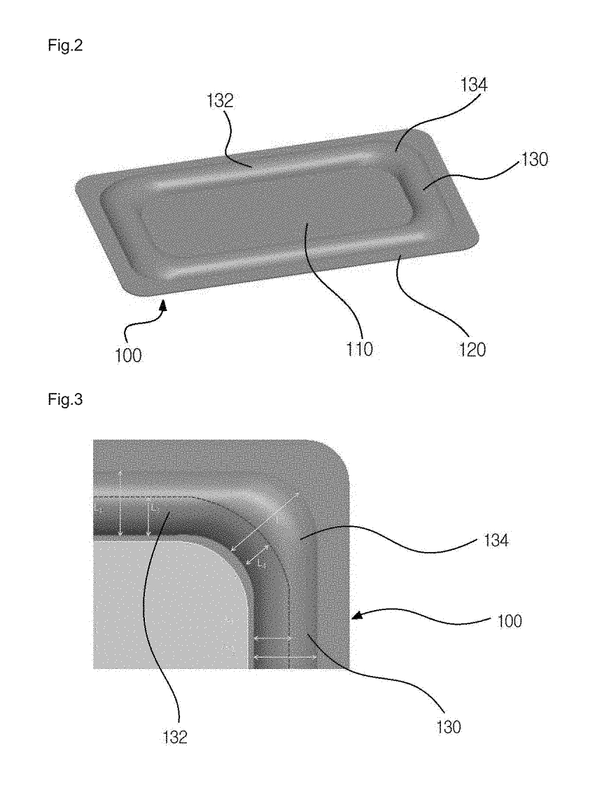

FIG. 2 shows a side diaphragm with a waterproof function according to an exemplary embodiment of the present invention.

The side diaphragm 100 according to the exemplary embodiment of the present invention includes a planar center portion 110, a planar outer peripheral portion 120, and a ring-shaped dome portion 130 projecting upward between the center portion 110 and the outer peripheral portion 120. The side diaphragm 100 does not have a perforated part at all, and does not have any projections or pleats other than the ring-shaped projecting dome portion 130.

Therefore, the side diaphragm 100 and the dome portion 130 of the side diaphragm 100 have excellent elastic and restoring forces. It is thus apparent that the side diaphragm 100 exposed to a high water pressure can be easily restored to fully perform the original function.

Meanwhile, a voice coil (not shown) is attached to the center portion 110, and the outer peripheral portion 120 is seated on a frame. Preferably, the height of the center portion 110 on which the voice coil is to be seated is equal to or lower than the height of the outer peripheral portion 120.

Here, preferably, the side diaphragm 100 has a thickness of at least 30 μm. If the side diaphragm 100 has a thickness less than 30 μm, then the dome portion 130 of the side diaphragm 100 does not have sufficient elasticity, as a result of which the dome portion 130 exposed to a high water pressure and deformed may not be restored with its own elasticity.

The side diaphragm 100 is generally formed in a rectangular shape. Here, this expression includes not only a rectangle but also a rectangle with rounded or chamfered corners. Therefore, the dome portion 130 is also generally formed in a rectangular shape with four straight parts 132 and four corner parts 134.

FIG. 3 is a detailed view showing the dome portion of the side diaphragm with the waterproof function according to the exemplary embodiment of the present invention.

As described above, the dome portion 130 of the side diaphragm 100 with the waterproof function according to the exemplary embodiment of the present invention includes four straight parts 132 and four corner parts 134. The dome portion 130 upwardly or downwardly projects, wherein an imaginary line connecting the highest projecting points, i.e., the highest points, when seen in the sectional view, is shown as a red dotted line.

The highest point of the dome portion 130 at the straight part 132 is located further outward than the center of the width of the dome portion 130. That is, when the width of the dome portion 130 at the straight part 132 is L₁ and the planar distance between the inner part of the dome portion 130 and the highest point is L₃, L₃>L₁/2. This structure serves to facilitate the vibration of the inner part of the dome portion 130 having a relatively large amplitude.

Meanwhile, the highest point of the dome portion 130 at the corner part 134 is located further inward than the center of the width of the dome portion 130. That is, when the width of the dome portion 130 at the corner part 134 is L₂ and the planar distance between the inner part of the dome portion 130 and the highest point is L₄, L₄<L₂/2. The width of the dome portion 130 at the corner part 134 is greater than at the straight part 132 because deformation easily occurs at the corner part 134.

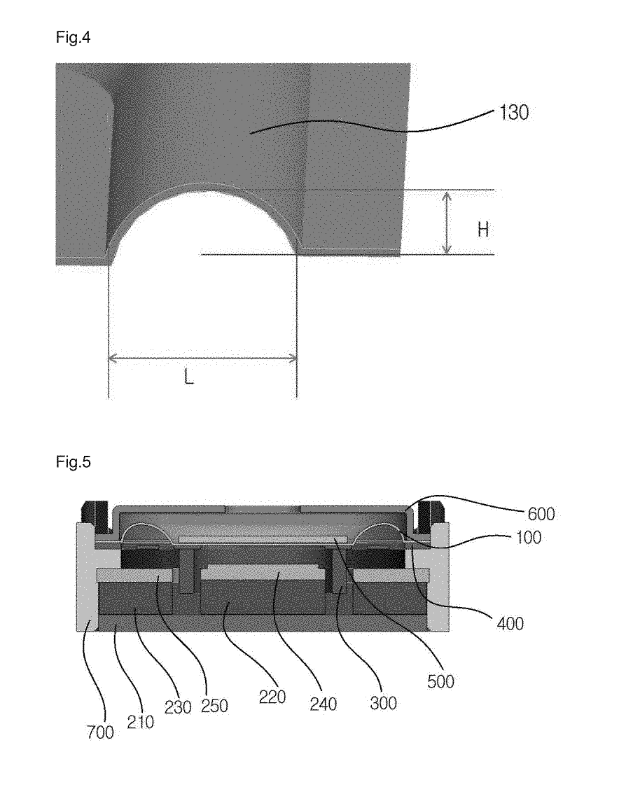

FIG. 4 is a sectional view showing part of the side diaphragm with the waterproof function according to the exemplary embodiment of the present invention. For the dome portion 130 of the side diaphragm with the waterproof function according to the exemplary embodiment of the present invention, the ratio of the height H of the dome portion 130 to the width L of the dome portion 130 is equal to or greater than 0.35. For example, when the dome portion 130 has a width of 1.0 mm, it preferably has a height of at least 0.35 mm.

FIG. 5 shows an example of a microspeaker having a side diaphragm with a waterproof function according to the present invention. For the microspeaker according to the present invention, a yoke 210, an inner-ring magnet 220, an outer-ring magnet 230, an inner-ring top plate 240, and an outer-ring top plate 250 are disposed in a frame 700, and a voice coil 300 is positioned in an air gap between the inner-ring magnet 220 and the outer-ring magnet 230, said voice coil 300 vibrating up and down when power is applied thereto. The voice coil 300 is mounted on a bottom surface of a damper 400, and a side diaphragm 100 and a center diaphragm 500 are provided on a top surface of the damper 400, vibrating together with the vibration of the voice coil 300 and generating a sound. A protector 600 is coupled thereon to protect the components provided inside the speaker. The protector 600 has an opening at the center to emit a sound and is wholly made of an SUS material. The frame 700, the damper 400, the side diaphragm 100 and the protector 600 are attached using a silicon bond to ensure airtightness and watertightness on the attached surfaces, which makes it possible to prevent the inflow of water through the attached surfaces of the respective components. The inflow of water is only possible through the opening formed in the protector 600.

In the meantime, the protector 600, which is made of an SUS material, can maintain its shape under a higher pressure than a plastic injection molding product, without being not deformed or damaged. Furthermore, the side diaphragm 100 and the protector 600 are attached to each other using a silicon bond, the adhesiveness between the side diaphragm 100 and the SUS material by the silicon bond is much stronger than the adhesiveness between the side diaphragm 100 and the plastic injection molding product by the silicon bond. Therefore, as the protector 600 is made of the SUS material, the watertightness between the side diaphragm 100 and the protector 600 can be improved, and the rigidity of the protector 600 itself can also be increased.

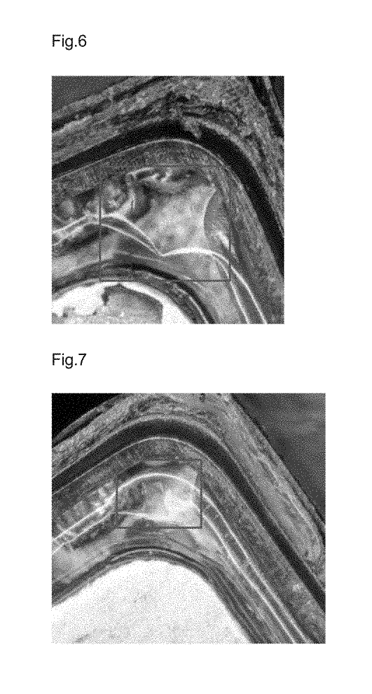

FIG. 6 is a photographic image of a comparative side diaphragm with a waterproof function, after applying a water pressure of 1 atm thereto, and FIG. 7 is a photographic image of the side diaphragm with the waterproof function according to the exemplary embodiment of the present invention, after applying a water pressure of 1 atm thereto. The side diaphragm of the comparative example of FIG. 6 is the same as the side diaphragm of the present invention in that it has a planar center portion, a planar outer peripheral portion, and a ring-shaped dome portion projecting upward between the center portion and the outer peripheral portion, wherein there is no perforated part and the dome portion does not have additional pleats. However, the highest point of the dome portion at the straight part is not located further outward than the center of the width of the dome portion, and the highest point of the dome portion at the corner part is not located further inward than the center of the width of the dome portion. That is, when the highest points of the dome portion at the straight part and the corner part are all at the center of the width of the dome portion, if the side diaphragm is deformed at a relatively high water pressure, it is not restored to the original state by itself.

FIG. 7 shows the side diaphragm with the waterproof function according to the exemplary embodiment of the present invention. The side diaphragm may be more or less deformed, while a relatively high water pressure is being applied thereto, but is restored close to the original state, after the water pressure is removed.

Referring to FIGS. 6 and 7 together, while the corner part of the comparative example is distorted, the corner part of the exemplary embodiment of the present invention is merely slightly deflected, which can be restored by the vibration of the air during the operation of the microspeaker.

While this invention has been described in connection with what is presently considered to be practical exemplary embodiments, it is to be understood by those skilled in the art that the invention is not limited to the disclosed embodiments, but on the contrary, is intended to cover various modifications and equivalent arrangements included within the spirit and scope of the appended claims.

What is claimed is:

1. A side diaphragm with a waterproof function for a microspeaker, the side diaphragm comprising:
a planar center portion;
a planar outer peripheral portion; and
a ring-shaped dome portion projecting upward between the center portion and the outer peripheral portion,
wherein there is no perforated part and the dome portion does not have additional pleats.

2. The side diaphragm of claim 1, wherein the side diaphragm is generally formed in a rectangular shape, and the dome portion has four corner parts and four straight parts, the highest point of the dome portion at the straight part being located further outward than the center of the width of the dome portion.

3. The side diaphragm of claim 1, wherein the side diaphragm is generally formed in a rectangular shape, and the dome portion has four corner parts and four straight parts, the highest point of the dome portion at the corner part being located further inward than the center of the width of the dome portion.

4. The side diaphragm of claim 1, wherein a height of the center portion is equal to or lower than a height of the outer peripheral portion.

5. The side diaphragm of claim 1, wherein a ratio of a height of the dome portion to a width of the dome portion is equal to or greater than 0.35.

6. The side diaphragm of claim 1, wherein the diaphragm has a thickness of at least 30 μm.

7. A microspeaker, comprising:
a frame;
a magnetic circuit disposed in the frame;
a side diaphragm comprising a planar center portion, a planar outer peripheral portion, and a ring-shaped dome portion projecting upward between the center portion and the outer peripheral portion;
a voice coil attached to the side diaphragm; and
a protector coupled to an upper portion of the frame and closely attached to the outer peripheral portion of the side diaphragm,
wherein the side diaphragm has no perforated part and the dome portion does not have additional pleats,
wherein the protector is wholly made of an SUS material.

8. The microspeaker of claim 7, wherein the protector and the side diaphragm are attached using a silicon bond.

9. The microspeaker of claim 7, wherein the side diaphragm is generally formed in a rectangular shape, and the dome portion has four corner parts and four straight parts, the highest point of the dome portion at the straight part being located further outward than the center of the width of the dome portion.

10. The microspeaker of claim 7, wherein the side diaphragm is generally formed in a rectangular shape, and the dome portion has four corner parts and four straight parts, the highest point of the dome portion at the corner part being located further inward than the center of the width of the dome portion.

11. The microspeaker of claim 7, wherein a height of the center portion is equal to or lower than a height of the outer peripheral portion.

12. The microspeaker of claim 7, wherein a ratio of a height of the dome portion to a width of the dome portion is equal to or greater than 0.35.

13. The microspeaker of claim 7, wherein the diaphragm has a thickness of at least 30 μm.
